(19) United States
(12) Patent Application Publication
(10) Pub. No.: US 2008/0311895 A1
(43) Pub. Date: Dec. 18, 2008

(54) Colorful Ring Back Tone Copying Method

(75) Inventors: Lingjuan Feng, Beijing (CN); Rongrong Yu, Beijing (CN); Nan Sun, Beijing (CN); Haohua Xu, Beijing (CN)

Correspondence Address: MERCHANT & GOULD PC, P.O. BOX 2903, MINNEAPOLIS, MN, 55402-0903, US

(73) Assignee: CHINA MOBILE COMMUNICATIONS CORPORATION, Xicheng District (CN)

(21) Appl. No.: 12/065,719

(22) PCT Filed: Aug. 24, 2006
(86) PCT No.: PCT/CN2006/002173

§ 371 Date: Aug. 18, 2008

(30) Foreign Application Priority Data
Sep. 7, 2005 (CN) 200510098760.1

(51) Int. Cl. H04M 3/42

(52) U.S. Cl. 455/414.2

(57) ABSTRACT

The present invention relates to a Colorful Ring Back Tone (CRBT) copying method, the method comprises: a calling mobile terminal initiating a call to a called mobile terminal and receiving a Ring Back Tone (RBT) sent by the CRBT service center; the mobile communication network authenticating it after receiving a CRBT copying request; if the authentication is passed, copying the RBT being currently played to a ring database of the calling mobile terminal and keeping playing the RBT until off-hook or on-hook; otherwise, keeping playing until off-hook or on-hook. The present invention relates to another CRBT copying method, the method comprises: a calling mobile terminal initiating a call to a called mobile terminal and receiving a RBT sent by the CRBT service center; the mobile communication network authenticating it after receiving a CRBT copying request; if the authentication is not passed, keeping playing the RBT until off-hook or on-hook; if the authentication is passed, enquiring the calling mobile terminal whether the copying should be taken; if it chooses to copy, copying the RBT being currently played to the ring database and keeping playing until off-hook or on-hook; otherwise, keeping playing until off-hook or on-hook.

### FIELD OF THE INVENTION

The present invention relates to a Colorful Ring Back Tone (CRBT) copying method, more particularly relates to a method for copying the CRBT being currently played and subscribed by the called mobile terminal to a ring database of the calling mobile terminal.

### BACKGROUND OF THE INVENTION

CRBT also can be called as colorful Ring Back Tone or individualized Ring Back Tone. In the CRBT technology, traditional “du, du” ring back tone (RBT) is replaced by music or voice subscribed by the subscriber, so that the calling subscriber can hear a colorful ring back tones when he is waiting the called subscriber answer. All the Chinese patents with application numbers of 031336994, 03150189, 03800092 and 200310100733 bring forward the methods for realizing the individualized ring back tone.

Up to now, there are mainly two matters that the called subscriber applies or chooses the CRBT. One is that the called subscriber goes to the business hall to apply for the CRBT service himself, and choose different CRBTs for different groups of the calling subscribers. This method causes the called subscriber's inconvenience in the term of time and can not realize that the subscriber chooses a CRBT he loves after trying. Another matter is that the called subscriber applies for the CRBT service by web and subscribes different special CRBTs for different calling subscriber groups. Comparing to the first matter, it has great improvement in the term of CRBT pre-experience and CRBT updating, and it conveniences the called subscriber greatly at time aspect if the network is convenience. However, there are a lot of kinds of CRBTs on the internet, of which one CRBT may have different effects because the CRBT is intercepted from different segment, or acted by different people, or acted in different languages, or having different levels of volume. Therefore, it will take much time and energy for the called subscriber to choose his or her favorite CRBT by trying CRBTs on the internet one by one.

### SUMMARY OF THE INVENTION

An object of the present invention is to provide a CRBT copying method in view of the shortcomings of the CRBT technology in the prior art, so that the calling subscriber can copy the CRBT listened currently to its ring database conveniently and quickly.

Another object of the present invention is to provide a CRBT copying method, so that the calling subscriber can copy the CRBT listened currently to its ring database conveniently and quickly, and can avoid a CRBT copying caused by the subscriber mispressing keys.

In order to accomplish above object, the present invention provides a CRBT copying method comprising:

in the mobile communication network, a calling mobile terminal initiating a call to a called mobile terminal and receiving a RBT sent by a CRBT service center;

said mobile communication network authenticating said calling mobile terminal after receiving a CRBT copying request message sent by said calling mobile terminal;

if the authentication is passed, said mobile communication network notifying said CRBT service center to copy the RBT being currently played to a ring database of said calling mobile terminal; said CRBT service center copying the RBT being currently played to the ring database of said calling mobile terminal; the CRBT service center keeping playing said RBT until the called mobile terminal is off-hook to answer or said calling mobile terminal and/or the called mobile terminal are/is on-hook;

if the authentication is not passed, the CRBT service center keeping playing said RBT until the called mobile terminal is off-hook to answer or said calling mobile terminal and/or the called mobile terminal are/is on-hook.

In order to accomplish another object, the present invention provides a CRBT copying method comprising:

in the mobile communication network, a calling mobile terminal initiating a call to a called mobile terminal and receiving a RBT sent by a CRBT service center;

said mobile communication network authenticating said calling mobile terminal after receiving a CRBT copying request message sent by said calling mobile terminal;

if said authentication is not passed, the CRBT service center keeping playing RBT until the called mobile terminal is off-hook to answer or said calling mobile terminal and/or the called mobile terminal are/is on-hook;

if the authentication is passed, said mobile communication network sending a message to said calling mobile terminal to enquire whether RBT copying should be conducted;

when said calling mobile terminal chooses to conduct said CRBT copying, said mobile communication network notifying said CRBT service center to copy the RBT being currently played to a ring database of said calling mobile terminal; said CRBT service center copying the CRBT being currently played to the ring database of said calling mobile terminal; the CRBT service center keeping playing said RBT until the called mobile terminal is off-hook to answer or said calling mobile terminal and/or the called mobile terminal are/is on-hook;

otherwise, the CRBT service center keeping playing said RBT until the called mobile terminal is off-hook to answer or said calling mobile terminal and/or the called mobile terminal are/is on-hook.

Therefore, the methods of the present invention realize that the CRBT being currently played is copied as a CRBT of said calling mobile terminal in real time and conveniently by the mobile communication network.

The technical solution of the present invention will be more fully described by the following detailed description of preferred embodiments of the present invention which is to be considered together with the accompanying drawings.

### BRIEF DESCRIPTION OF THE DRAWINGS

FIG. 1 is a flow chart of CRBT copying in the embodiment 1 according to the present invention.

FIG. 2 is a flow chart of CRBT copying in the embodiment 2 according to the present invention.

FIG. 3 is a flow chart of CRBT copying in the embodiment 3 according to the present invention.

FIG. 4 is a flow chart of CRBT copying in the embodiment 4 according to the present invention.

FIG. 5 is a flow chart of CRBT copying in the embodiment 5 according to the present invention.

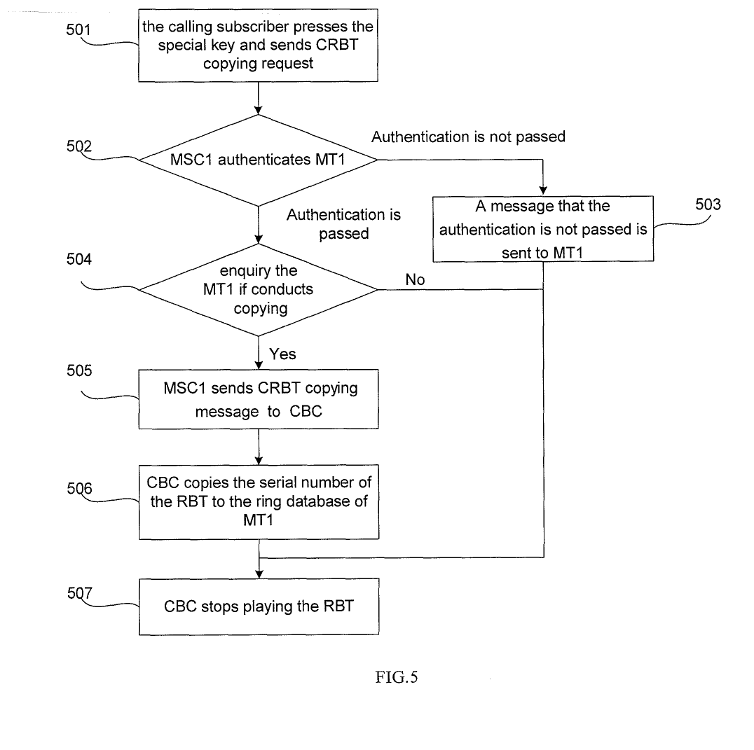

### DETAILED DESCRIPTION OF THE PREFERRED EMBODIMENTS

The present invention is to copy the CRBT listened currently by the calling mobile terminal as a CRBT of the calling mobile terminal through the mobile communication network.

Said mobile communication network includes: a calling mobile terminal MT1, a called mobile terminal MT2, a first mobile switching center MSC1 in which the calling mobile terminal MT1 is registered, a second mobile switching center MSC2 in which the called mobile terminal MT2 is registered, a CRBT service center CBC connected with said first mobile switching center MSC1 and the second mobile switching center MSC2, and a short message service center SMSC connected with said CRBT service center CBC and the first mobile switching center MSC1.

The CRBT service center CBC is used for storing and managing CRBT resources; and the short message service center SMSC is used for sending message to the calling mobile terminal MT1.

### Embodiment 1

In this embodiment, the CRBT service center CBC is considered as an authentication unit and is responsible for authenticating the calling mobile terminal MT1.

The steps of the embodiment 1 concretely comprise:

The calling mobile terminal MT1 initiates a call to the called mobile terminal MT2 subscribing the CRBT service by the first mobile switching center MSC1 and the second switching center MSC2, and receives the RBT played by the CRBT service center CBC;

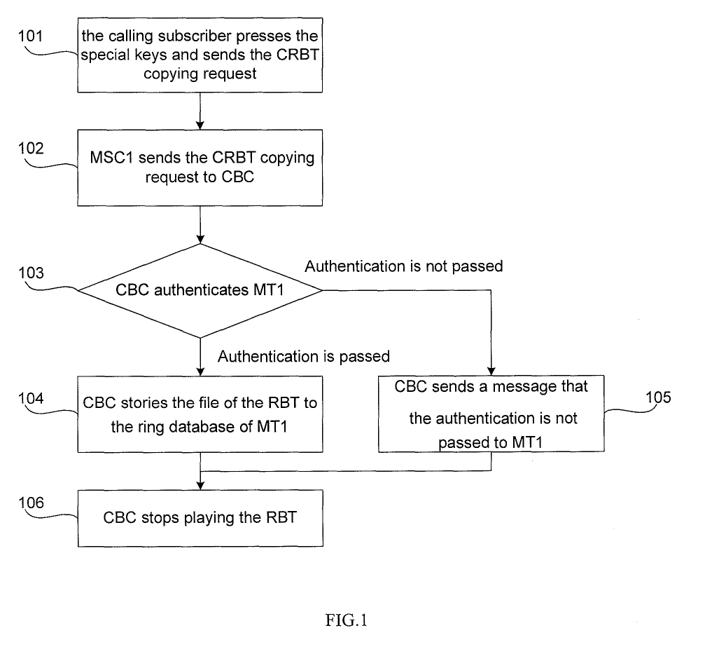

During the process of the CRBT service center CBC playing the CRBT, if the calling subscriber is interested in the RBT being currently played and wishes to store this RBT in his own ring database, he can conduct CRBT copying. As shown in FIG. 1, the detailed process comprises the following steps:

Step 101: the calling subscriber sends a CRBT copying request by pressing a special key of the calling mobile terminal MT1, such as “*” key;

Step 102: the first mobile switching center MSC1 sends a CRBT copying request message including the number of the calling mobile terminal and the key value of the special key to the CRBT service center CBC after receiving the above CRBT copying request;

Step 103: the CRBT service center CBC authenticates the calling mobile terminal MT1 and judges whether the calling mobile terminal MT1 is CRBT subscriber after receiving the CRBT copying request message. If the authentication is passed, the step 104 is executed, otherwise, the step 105 is executed;

The detailed authentication step is that the CRBT service center CBC queries in the CRBT subscriber database according to the number of the calling mobile terminal MT1; if the number of the calling mobile terminal MT1 is included in said database, the authentication is passed; otherwise, the authentication is not passed. During the process of authentication, the region registered, the status of the present subscriber and so on, also can be taken into consideration;

Step 104: the CRBT service center CBC copies the file of the RBT being currently played to the ring database of the calling mobile terminal MT1, and then the step 106 is executed;

Step 105: the CRBT service center CBC sends a message that the authentication is not passed to the calling mobile terminal MT1 by the short message service center SMSC;

Step 106: the CRBT service center CBC keeps playing the RBT until the called mobile terminal MT1 is off-hook to answer, or said calling mobile terminal MT1 and/or the called mobile terminal MT2 are/is on-hook.

In the process of executing the step 101 to step 105, the CRBT service center CBC keeps playing the RBT for the calling mobile terminal MT1 all through.

In addition, the calling mobile terminal MT1 and the called mobile terminal MT2 also can be registered in the same mobile switching center, and the CRBT copying process is the same with the present embodiment.

The present embodiment accomplishes that the subscriber can copy the CRBT being currently played to his own ring database by pressing the special key, which makes the subscriber choose the CRBT more convenient and quick.

### Embodiment 2

In this embodiment, the first mobile switching center MSC1 is responsible for authenticating. The first mobile switching center MSC1 will send the CRBT copying message to the CRBT service center CBC only if the authentication is passed; and what copied is the serial number of the RBT when copies the RBT but not whole RBT file.

The steps of this embodiment concretely comprise:

The calling mobile terminal MT1 initiates a call to the called mobile terminal MT2 subscribing the CRBT service by the first mobile switching center MSC1 and the second switching center MSC2, and receives the RBT played by the CRBT service center CBC;

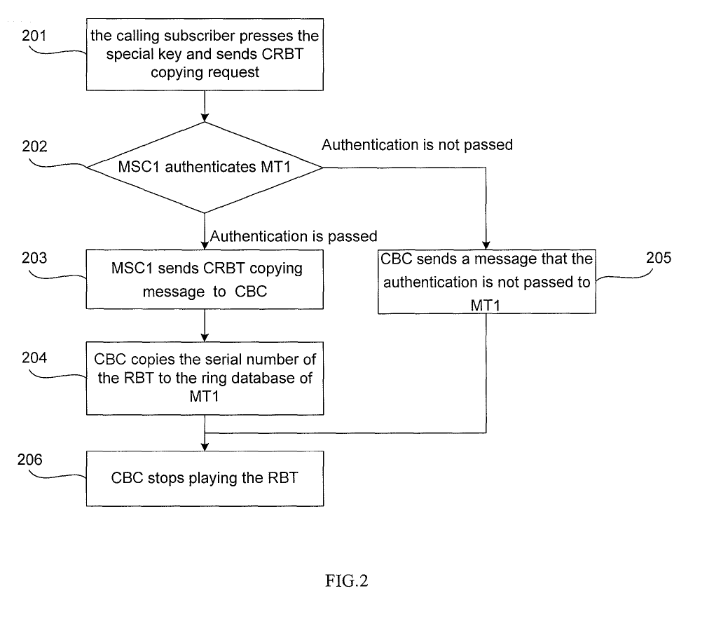

During the process of the CRBT service center CBC playing the CRBT, if the calling subscriber is interested in the RBT being currently played and wishes to store this RBT in his own ring database, he can conduct CRBT copying. As shown in FIG. 2, the detailed process comprises the following steps:

Step 201: the calling subscriber sends a CRBT copying request by pressing a special key of the calling mobile terminal MT1, such as “*” key;

Step 202: the first mobile switching center MSC1 detects the home location register HLR1 of the calling mobile terminal MT1, authenticates the calling mobile terminal MT1 and judges whether the calling mobile terminal MT1 is CRBT subscriber; if the calling mobile terminal MT1 is CRBT subscriber, the authentication is passed and the step 203 is executed, otherwise, the authentication is not passed and then the step 205 is executed. During the process of authentication, the status of the present subscriber and other information also can be taken into consideration;

Step 203: the first mobile switching center MSC1 sends a CRBT copying message including the number of the calling mobile terminal MT1 and the key value of the special key to the CRBT service center CBC;

Step 204: the CRBT service center CBC copies the serial number of the RBT being currently played to the ring database of the calling mobile terminal MT1 after receiving the above CRBT copying message, and sends a short message of the success for copying to the calling mobile terminal MT1 by the short message service center SMSC; and then the step 206 is executed;

Step 205: the first mobile switching center MSC1 sends a message that the authentication is not passed to the calling mobile terminal MT1 by the short message service center SMSC;

Step 206: the CRBT service center keeps playing CRBT until the called mobile terminal MT1 is off-hook to answer, or said calling mobile terminal MT1 and/or the called mobile terminal MT2 are/is on-hook.

In the process of executing the step 201 to step 205, the CRBT service center CBC keeps playing the RBT for the calling mobile terminal MT1 all through.

In addition, the calling mobile terminal MT1 and the called mobile terminal MT2 in the above embodiment also can be registered in the same mobile switching center, and the CRBT copying process is the same with the present embodiment.

The present embodiment accomplishes that the subscriber can copy the CRBT being currently played to his own ring database by pressing the special key, which makes the subscriber choose the CRBT more convenient and quick. What differs from the embodiment 1 is that the authentication in the present embodiment is taken charge of by the first mobile switching center MSC1, and if the authentication is not passed, the CRBT copying request will not be sent to the CRBT service center CBC. Therefore the data transmission quantity will be smaller than the embodiment 1.

### Embodiment 3

In the present embodiment, in order to avoid CRBT copying caused by the calling subscriber mispressing keys, the step of CRBT service center CBC enquiring the subscriber that if he agrees with CRBT copying is added before the CRBT service center CBC copying the CRBT.

In the present embodiment, the CRBT service center CBC is as the authentication unit and is responsible for authenticating the calling mobile terminal MT1. What is copied is the whole RBT file when copies.

The steps of this embodiment concretely comprise:

The calling mobile terminal MT1 initiates a call to the called mobile terminal MT2 subscribing the CRBT service by the first mobile switching center MSC1 and the second switching center MSC2, and receives the RBT played by the CRBT service center CBC;

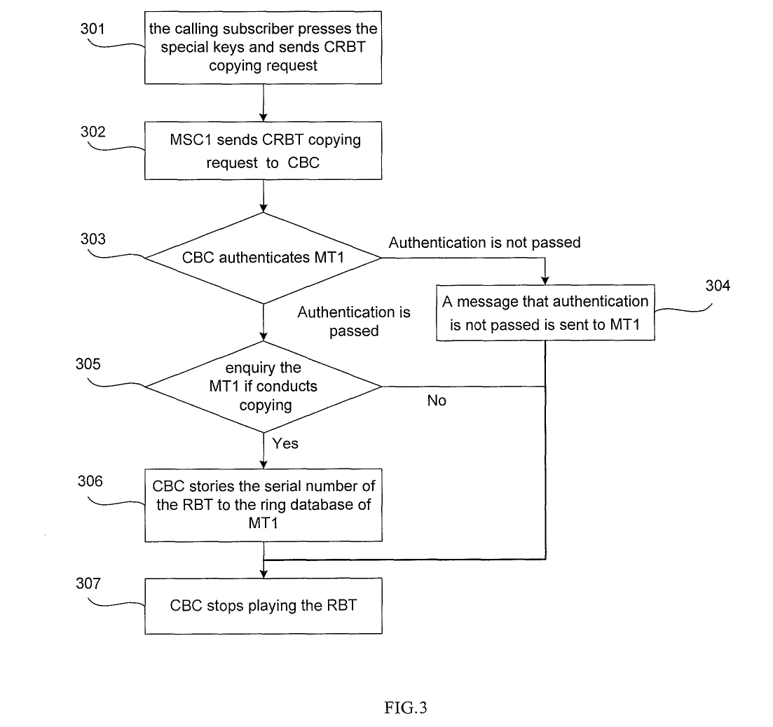

During the process of the CRBT service center CBC playing the CRBT, if the calling subscriber is interested in the RBT being currently played and wishes to store this RBT in his own ring database, he can conduct CRBT copying. As shown in FIG. 3, the detailed process comprises the following steps:

Step 301: the calling subscriber sends a CRBT copying request by pressing a special key of the calling mobile terminal MT1, such as “*” key;

Step 302: the first mobile switching center MSC1 sends a CRBT copying request message including the number of the calling mobile terminal and the key value of the special key to the CRBT service center CBC after receiving the above CRBT copying request;

Step 303: the CRBT service center CBC authenticates the calling mobile terminal MT1 and judges whether the calling mobile terminal MT1 is CRBT subscriber after receiving the CRBT copying request message. If the authentication is passed, the step 305 is executed, otherwise, the step 304 is executed;

The detailed authentication step is that the CRBT service center CBC queries in the CRBT subscriber database according to the number of the calling mobile terminal MT1; if the number of the calling mobile terminal MT1 is included in said database, the authentication is passed; otherwise, the authentication is not passed. During the process of authentication, the region registered, the status of the present subscriber and so on, also can be taken into consideration;

Step 304: the CRBT service center CBC sends a message that the authentication is not passed to the calling mobile terminal MT1 by the short message service center SMSC, and then step 307 is executed;

Step 305: the CRBT service center CBC sends a message to the calling mobile terminal MT1 to enquire whether the calling mobile terminal conducts CRBT copying; if the calling mobile terminal MT1 chooses to conduct CRBT copying, the step 306 is executed, otherwise, the step 307 is executed;

Step 306: the CRBT service center CBC copies the serial number of the RBT being currently played to the ring database of the calling mobile terminal MT1, and sends a short message of the success for copying to the calling mobile terminal MT1 by the short message service center SMSC;

Step 307: the CRBT service center CBC keeps playing the RBT until the called mobile terminal MT1 is off-hook to answer, or said calling mobile terminal MT1 and/or the called mobile terminal MT2 are/is on-hook.

In the process of executing the step 301 to step 306, the CRBT service center CBC keeps playing the RBT for the calling mobile terminal MT1 all through.

In addition, the calling mobile terminal MT1 and the called mobile terminal MT2 also can be registered in the same mobile switching center, and the CRBT copying process is the same with the present embodiment.

The present embodiment accomplishes that the subscriber can copy the CRBT being currently played to his own ring database by pressing the special key, which makes the subscriber choose the CRBT more convenient and quick. And the CRBT copying caused by the subscriber mispressing keys can be avoided effectively by adding the step of enquiring the subscriber that if he agrees with CRBT copying.

### Embodiment 4

In this embodiment, the first mobile switching center MSC1 is responsible for authenticating. The first mobile switching center MSC1 will send the CRBT copying message to the CRBT service center CBC only if the authentication is passed; and the step of CRBT service center CBC enquiring the subscriber that if he agrees with CRBT copying is added in order to avoid CRBT copying caused by the subscriber misspressing keys.

The steps of this embodiment concretely comprise:

The calling mobile terminal MT1 initiates a call to the called mobile terminal MT2 subscribing the CRBT service by the first mobile switching center MSC1 and the second switching center MSC2, and receives the RBT played by the CRBT service center CBC;

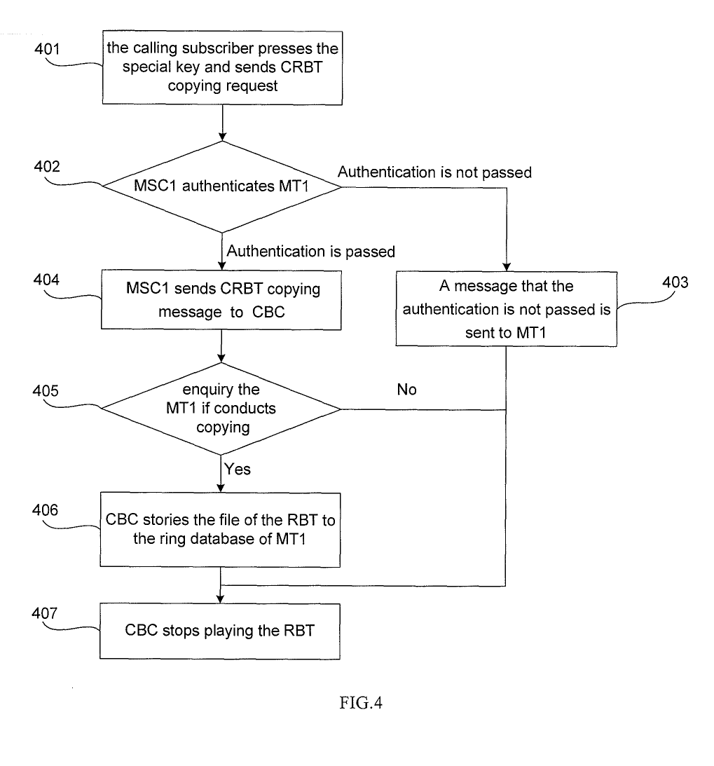

During the process of the CRBT service center CBC playing the CRBT, if the calling subscriber is interested in the RBT being currently played and wishes to store this RBT in his own ring database, he can conduct CRBT copying. As shown in FIG. 4, the detailed process comprises the following steps:

Step 401: the calling subscriber sends a CRBT copying request by pressing a special key of the calling mobile terminal MT1, such as “*” key;

Step 402: the first mobile switching center MSC1 detects the home location register HLR1 of the calling mobile terminal MT1, authenticates the calling mobile terminal MT1 and judges whether the calling mobile terminal MT1 is CRBT subscriber; if the calling mobile terminal MT1 is CRBT subscriber, the authentication is passed and the step 404 is executed, otherwise, the authentication is not passed, and then the step 403 is executed;

Step 403: the first mobile switching center MSC1 sends a message that the authentication is not passed to the calling mobile terminal MT1 by the short message service center SMSC, and then the step 407 is executed;

Step 404: the calling mobile switching center MSC1 sends a CRBT copying message including the number of the calling mobile terminal MT1 and the key value of the special key to the CRBT service center CBC;

Step 405: the CRBT service center CBC sends a message to the calling mobile terminal MT1 to enquire whether the calling mobile terminal conducts CRBT copying; if the calling mobile terminal MT1 chooses to conduct CRBT copying, the step 406 is executed, otherwise, the step 407 is executed;

Step 406: the CRBT service center CBC copies the whole CRBT file being currently played to the ring database of the calling mobile terminal MT1;

Step 407: the CRBT service center CBC keeps playing the RBT until the called mobile terminal MT1 is off-hook to answer, or said calling mobile terminal MT1 and/or the called mobile terminal MT2 are/is on-hook.

In the process of executing the step 401 to step 406, the CRBT service center CBC keeps playing the RBT for the calling mobile terminal MT1 all through.

In addition, the calling mobile terminal MT1 and the called mobile terminal MT2 also can be registered in the same mobile switching center, and the CRBT copying process is the same with the present embodiment.

The present embodiment accomplishes that the subscriber can copy the CRBT being currently played to his own ring database by pressing the special key, which makes the subscriber choose the CRBT more convenient and quick. The authentication in the present embodiment is taken charge of by the first mobile switching center MSC1, and if the authentication is not passed, the CRBT copying request will not be sent to the CRBT service center CBC, and therefore, the data transmission quantity will be smaller than the embodiment 3. And the CRBT copying caused by the subscriber misspressing keys can be avoided effectively by adding the step of enquiring the subscriber that if he agrees with CRBT copying.

### Embodiment 5

In this embodiment, the first mobile switching center MSC1 is responsible for the authentication. The first mobile switching center MSC1 enquires the subscriber that if he agrees with CRBT copying in order to avoid CRBT copying caused by the subscriber misspressing keys.

The steps of this embodiment concretely comprise:

The calling mobile terminal MT1 initiates a call to the called mobile terminal MT2 subscribing the CRBT service by the first mobile switching center MSC1 and the second switching center MSC2, and receives the RBT played by the CRBT service center CBC;

During the process of the CRBT service center CBC playing the CRBT, if the calling subscriber is interested in the RBT being currently played and wishes to store this RBT in his own ring database, he can conduct CRBT copying. As shown in FIG. 4, the detailed process comprises the following steps:

Step 501: the calling subscriber sends a CRBT copying request by pressing a special key of the calling mobile terminal MT1, such as “*” key;

Step 502: the first mobile switching center MSC1 detects the home location register HLR1 of the calling mobile terminal MT1, authenticates the calling mobile terminal MT1 and judges whether the calling mobile terminal MT1 is CRBT subscriber; if the calling mobile terminal MT1 is CRBT subscriber, the authentication is passed and the step 504 is executed, otherwise, the authentication is not passed, and then the step 503 is executed;

Step 503: the first mobile switching center MSC1 sends a message that the authentication is not passed to the calling mobile terminal MT1 by the short message service center SMSC, and then the step 507 is executed;

Step 504: the first mobile switching center MSC1 sends a message to the calling mobile terminal enquiring MT1 to enquire whether the calling mobile terminal MT1 conducts CRBT copying; if the calling mobile terminal MT1 chooses to conduct CRBT copying, the step 505 is executed, otherwise, the step 507 is executed;

Step 505: the calling mobile switching center MSC1 sends a CRBT copying message including the number of the calling mobile terminal MT1 and the key value of the special key to the CRBT service center CBC;

Step 506: the CRBT service center CBC copies the serial number of whole RBT being currently played to the ring database of the calling mobile terminal MT1 after receiving above CRBT copying message, and sends a short message of the success for copying to the calling mobile terminal MT1 by the short message service center SMSC;

Step 507: the CRBT service center CBC keeps playing the RBT until the called mobile terminal MT1 is off-hook to answer, or said calling mobile terminal MT1 and/or the called mobile terminal MT2 are/is on-hook.

In the process of executing the step 501 to step 506, the CRBT service center CBC keeps playing the RBT for the calling mobile terminal MT1 all through.

In addition, the calling mobile terminal MT1 and the called mobile terminal MT2 also can be registered in the same mobile switching center, and the CRBT copying process is the same with the present embodiment.

The present embodiment accomplishes that the subscriber can copy the CRBT being currently played to his own ring database by pressing the special key, which makes the subscriber choose the CRBT more convenient and quick. The first mobile switching center enquires the subscriber that if he agrees with CRBT copying, at the same time that CRBT copying caused by subscriber misspressing keys can be avoided effectively, the data transmission quantity will be smaller than in embodiment 4.

Finally, it should be understood that the above embodiments are only used to explain, but not to limit the technical solution of the present invention. In despite of describing the present invention in detail with reference to the preferred embodiments, it should be understood that various modifications, changes or equivalent replacements could be made by an ordinary person skilled in the relevant field without departing from the spirit and scope of the technical solution of the present invention, which should be covered in the extent of the claims of the present invention.

1. A Colorful Ring Back Tone (CRBT) copying method comprising:
in the mobile communication network, a calling mobile terminal initiating a call to a called mobile terminal and receiving a Ring Back Tone (RBT) sent by a CRBT service center;
wherein the method further comprises:
said mobile communication network authenticating said calling mobile terminal after receiving a CRBT copying request message sent by said calling mobile terminal;
if the authentication is passed, said mobile communication network notifying said CRBT service center to copy the RBT being currently played to a ring database of said calling mobile terminal; said CRBT service center copying the RBT being currently played to the ring database of said calling mobile; the CRBT service center keeping playing said RBT until the called mobile terminal is off-hook to answer said calling mobile terminal and/or the called mobile terminal are/is on-hook;
if the authentication is not passed, the CRBT service center keeping playing said RBT until the called mobile terminal is off-hook to answer or said calling mobile terminal and/or the called mobile terminal are/is on-hook.

2. The method as claimed in claim 1, wherein said CRBT copying request message is a keypad message sent by said calling mobile terminal.

3. The method as claimed in claim 1, wherein the unit for authenticating is said CRBT service center.

4. The method as claimed in claim 3, wherein the step of said authentication comprises:
said CRBT service center querying in its database according to the number of said calling mobile terminal; if the number of the calling mobile terminal is included in said database, the authentication being passed, otherwise, the authentication not being passed.

5. The method as claimed in claim 1, wherein the step of said authentication comprises:
a mobile switching center of said calling mobile terminal detecting a home location register of said calling mobile terminal and determining whether said calling mobile terminal is a CRBT subscriber, if he is, the authentication being passed, otherwise, the authentication not being passed.

6. The method as claimed in claim 1, wherein said mobile communication network sends a message that authentication is not passed to said calling mobile terminal after said authentication is not passed.

7. The method as claims in claim 1, wherein the step of said CRBT service center copying said RBT being currently played to the ring database of said calling mobile terminal concretely is:
said CRBT service center copying the file of said RBT to the ring database of said calling mobile terminal; or
said CRBT service center copying the serial number of said RBT to the ring database of said calling mobile terminal.

8. The method as claimed in claim 1, wherein the CRBT service center sends a message of the success for copying to said calling mobile terminal after copying.

9. A CRBT copying method comprising:
in the mobile communication network, a calling mobile terminal initiating a call to a called mobile terminal and receiving a RBT sent by a CRBT service center;
wherein the method further comprises:
said mobile communication network authenticating said calling mobile terminal after receiving a CRBT copying request message sent by said calling mobile terminal;
if the authentication is not passed, the CRBT service center keeping playing RBT until the called mobile terminal is off-hook to answer or said calling mobile terminal and/or the called mobile terminal are/is on-hook;
if the authentication is passed, said mobile communication network sending a message to said calling mobile terminal to enquire whether RBT copying should be conducted;
when said calling mobile terminal chooses to conduct said CRBT copying, said mobile communication network notifying said CRBT service center to copy the RBT being currently played to a ring database of said calling mobile terminal; said CRBT service center copying the CRBT being currently played to the ring database of said calling mobile terminal; the CRBT service center keeping playing said RBT until the called mobile terminal is off-hook to answer or said calling mobile terminal and/or the called mobile terminal are/is on-hook;
otherwise, the CRBT service center keeping playing said RBT until the called mobile terminal is off-hook to answer or said calling mobile terminal and/or the called mobile are/is on-hook.

10. The method as claimed in claim 9, wherein said CRBT copying request message is a keypad message sent by said calling mobile terminal.

11. The method as claimed in claim 9, wherein the unit for authenticating is said CRBT service center.

12. The method as claimed in claim 11, wherein the step of said authentication comprises:
said CRBT service center querying in its database according to the number of said calling mobile terminal; if the number of the calling mobile terminal is included in said database, the authentication being passed, otherwise, the authentication not being passed.

13. The method as claimed in claim 9, wherein the step of said authentication comprises:
a mobile switching center of said calling mobile terminal detecting a home location register of said calling mobile terminal and determining whether said calling mobile terminal is a CRBT subscriber, if he is, the authentication being passed, otherwise, the authentication not being passed.

14. The method as claimed in claim 9, wherein said mobile communication network sends a message that authentication is not passed to said calling mobile terminal after said authentication is not being passed.

15. The method as claimed in claim 9, wherein the step of said CRBT service center copying said RBT being currently played to the ring database of said calling mobile terminal concretely is:
said CRBT service center copying the file of said RBT to the ring database of said calling mobile terminal; or
said CRBT service center copying the serial number of said RBT to the ring database of said calling mobile terminal.

16. The method as claimed in claim 9 or 15, wherein said CRBT service center sends a message of the success of copying to said calling mobile terminal after copying.

17. The method as claimed in claim 7, wherein the CRBT service center sends a message of the success for copying to said calling mobile terminal after copying.

18. The method as claimed in claim 15, wherein said CRBT service center sends a message of the success of copying to said calling mobile terminal after copying.
